(19) United States
(12) Patent Application Publication
(10) Pub. No.: US 2007/0259085 A1
(43) Pub. Date: Nov. 8, 2007

(54) Method for Making a Predetermined Quantity of Beverage

(75) Inventors: Hans Kodden, Hoogeveen (NL); Pieter Berend Bosstad, Hoogeveen (NL); Edwin Wilco Drost, Hoogeveen (NL); Rodin Enne Bruinsma, Hoogeveen (NL)

Correspondence Address: PHILIPS ELECTRONICS NORTH AMERICA CORPORATION;INTELLECTUAL PROPERTY & STANDARDS, 370 W. TRIMBLE ROAD MS 91/MG, SAN JOSE, CA, 95131, US

(73) Assignee: KONINKLIJKE PHILIPS ELECTRONICS N.V., Eindhoven (NL)

(21) Appl. No.: 11/630,301

(22) PCT Filed: Jun. 23, 2005
(86) PCT No.: PCT/IB05/52072

§ 371 Date: Dec. 19, 2006

(30) Foreign Application Priority Data
Jun. 29, 2004 (EP) 04103021.4

(51) Int. Cl. A23F 5/24; A23F 3/18; A47J 31/00; A47J 31/02

(52) U.S. Cl. 426/433; 426/434; 426/435; 99/281; 99/300

(57) ABSTRACT

A coffeemaker (1) comprises a boiler (6) for heating water to a predetermined temperature, and a pump (4) for forcing a predetermined quantity of water to flow through a filter containing ground coffee beans. The coffeemaker is capable of making a single quantity and a double quantity of coffee. The volume of a container of the boiler is smaller than the volume of the total quantity of water required for obtaining the double quantity of coffee. During the process of making the double quantity of coffee, a first quantity of water is heated inside the boiler to the predetermined temperature and subsequently conducted through the coffee filter, whereupon a second quantity of fresh water is conducted through the coffee filter as well. The temperatures of the first quantity and the second quantity are different. By supplying the water in portions having different temperatures, the taste of the coffeemaker comprises a boiler for heating water to a predetermined temperature, and a pump for forcing a predetermined quantity of water to flow through a filter containing ground coffee beans. The coffeemaker is capable of making a single quantity an a double quantity of coffee. The volume of a container of the boiler is smaller than the volume of the total quantity of water required for obtaining the double quantity of coffee. During the process of making the double quantity of coffee, a first quantity of water is heated inside the boiler to the predetermined temperature and subsequently conducted through the coffee filter, whereupon a second quantity of fresh water is conducted through the coffee filter as well. The temperature of the first quantity and the second quantity are different. By supplying the water in portions having different temperatures, the taste of the obtained coffee is influenced.

The present invention relates to a method for making a predetermined quantity of beverage such as coffee or tea, wherein a predetermined quantity of water is conducted through a quantity of extractable material.

For example, in the case of coffee, the extractable material comprises ground coffee beans, whereas in the case of tea, the extractable material comprises fragments of tea leaves.

A basic principle of making coffee is letting water come into contact with ground coffee beans. In most cases, the ground coffee beans are contained by a filter, which is capable of letting pass the water, while keeping the ground coffee beans inside.

Many types of devices for making coffee have been developed, which are all arranged for carrying out the above-mentioned well-known method of conducting a predetermined quantity of water through a quantity of ground coffee beans contained by a filter. The filter may for example be a paper filter, but may also be an open box of plastic or metal having tiny holes in at least one of its walls. In the following, the generally known term “coffee maker” will be used for indicating a device for making coffee.

One known type of coffee maker comprises a brew chamber in which the coffee is actually made. In case a user desires to obtain a quantity of coffee, he places a coffee pad comprising an envelope filled with a quantity of ground coffee beans in the brew chamber. During operation of the coffee maker, a quantity of water is forced to flow through the coffee pad. In the process, the envelope acts as a filter. In this way, on the basis of the interaction between the pressurized water and the coffee pad inside the brew chamber, the desired quantity of coffee is obtained.

For the purpose of heating the water to a predetermined temperature, usually about 95° C., the coffee maker comprises a boiler having a container for containing the water and heating means for heating the water. For the purpose of pressurizing the water, the coffee maker comprises a pump. The pump, the boiler and the brew chamber are interconnected by means of tubes for transporting water.

In a preferred embodiment, the coffee maker is arranged such as to be capable of supplying different quantities of coffee, for example a quantity with which one average coffee cup may be filled, and a quantity with which two average coffee cups may be filled. In such an embodiment, the coffee maker comprises a controller for controlling the operation of the coffee maker, and at least one input member such as a button with which the user can program the controller according to his desires. In order to make sure that the concentration of the obtained coffee is independent of the quantity that is supplied, the number of coffee pads needs to be chosen in accordance with the desired quantity. Therefore, if it takes one coffee pad to obtain one cup of coffee having a predetermined concentration, it takes two coffee pads to obtain two cups of coffee having more or less the same concentration. When the user wants the coffee maker to make one cup of coffee, the controller activates the pump during a single length of time, and a single quantity of water is forced to flow through the single coffee pad accommodated by the brew chamber. When the user wants the coffee maker to make two cups of coffee, the controller activates the pump during a double length of time, and a double quantity of water is forced to flow through the two coffee pads accommodated by the brew chamber.

Although measures are taken to ensure that the concentration of the coffee is independent of the quantity that is supplied, in practice, the taste of coffee which is obtained by letting the coffee maker supply a single quantity appears to be different from the taste of coffee which is obtained by letting the coffee maker supply a double quantity. This is a result of the fact that the so-called extraction time, i.e. the time it takes for the water to flow through the coffee pad(s), is different for the different situations: the extraction time associated with a double quantity of coffee is approximately twice as long as the extraction time associated with a single quantity of coffee.

It is an objective of the present invention to provide a solution to the above-mentioned problem of the taste of the obtained coffee being different for different quantities. According to the present invention, the objective is achieved by applying a method for making a predetermined quantity of beverage, wherein a predetermined quantity of water is conducted through a quantity of extractable material, and wherein the predetermined quantity of water is supplied in at least two portions having different temperatures.

Research which has been performed in the context of the present invention has shown that when the method according to the present invention is applied in case a double quantity of coffee is desired, it is possible to obtain a taste, which is similar to the taste of a single quantity of coffee. It has appeared that the influence of the longer extraction time on the taste of the obtained coffee may be removed by successively conducting different portions of water having different temperatures through the coffee pads accommodated by the brew chamber.

The method according to the present invention may be laid down in the controller of a coffee maker, wherein the controller is programmed such as to follow the steps of the method only in case it receives a signal that the user desires to have two cups of coffee. In case it receives a signal that the user desires to have one cup of coffee, a known procedure is performed, wherein the total quantity of water that is forced to flow through the coffee pad accommodated by the brew chamber is supplied in one portion having one temperature.

In a coffee maker in which the controller is programmed such as to follow the steps of the method according to the present invention when two cups of coffee need to be supplied, the volume of the container of the boiler may be reduced. In a known coffee maker, the volume of the container is at least equal to the volume of the quantity of water associated with two cups, so that the boiler is capable of putting the temperature of the entire quantity of water needed in the process of making two cups of coffee to a predetermined level. When the method according to the invention is applied, there is no need for the volume of the container to be larger than the volume of the largest portion of the predetermined quantity of water. For example, if the quantity of water needed for making two cups of coffee is supplied in two portions, wherein the volume of a first portion is 75% of the volume of the total quantity and the volume of a second portion is 25% of the volume of the total quantity, the largest volume that is required is 75% of the volume of the total quantity. Consequently, it is sufficient for the volume of the container to substantially correspond to 75% of the volume of the total quantity. Naturally, an important advantage of applying a smaller boiler 6 is that less time is needed for heating the water contained by the boiler 6.

It is noted that an obvious solution to the problem of the different extraction times in the different processes of making one cup of coffee and two cups of coffee would be realizing the same extraction time for both processes, for example by applying a higher pumping speed in the process of making two cups of coffee. However, in practical cases, such obvious solution is not applicable, as it brings along a number of negative effects. For example, in case the process of making coffee involves obtaining a creamy layer on the coffee, the formation of such a layer is disturbed by a higher pumping speed. Furthermore, a higher pumping speed leads to a larger pressure drop in the device, which is applied for making the coffee, so that a more robust and heavy design of the device is needed to withstand the pressure drop. When the solution according to the present invention is applied, such negative effects are avoided.

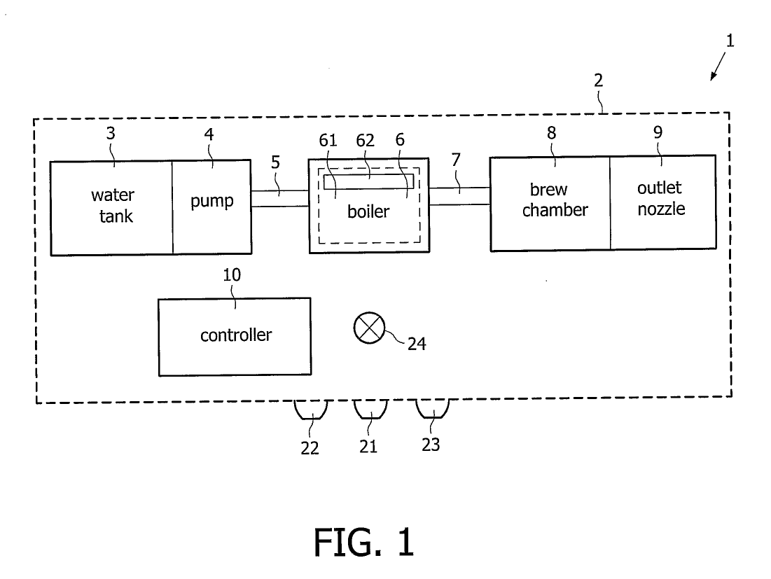

The present invention will now be explained in greater detail with reference to the FIG. 1, which diagrammatically shows various components of a coffee maker.

FIG. 1 diagrammatically shows various components of a coffee maker 1. This coffee maker 1 is to be regarded as just one of the numerous possible embodiments of a coffee maker.

A first shown component of the coffee maker 1 is a housing 2 for accommodating most of the components of the coffee maker 1. At an outside of the housing 2, buttons 21, 22, 23 are arranged, which are to be pressed by a user of the coffee maker. One of the buttons 21, 22, 23 is referred to as main button 21, and needs to be pressed by the user in case he wants to activate or turn off the coffee maker 1. Another of the buttons 21, 22, 23 is referred to as one cup button 22, and needs to be pressed at a certain stage in a coffee making procedure in case the user desires the coffee maker 1 to deliver a quantity of coffee which is associated with one cup. Yet another of the buttons 21, 22, 23 is referred to as two cups button 23, and needs to be pressed at a certain stage in a coffee making procedure in case the user desires the coffee maker 1 to deliver a quantity of coffee which is associated with two cups. Besides the buttons 21, 22, 23, an indicator light 24 is arranged at the outside of the housing 2.

A second shown component of the coffee maker 1 is a water tank 3 for containing water. This water tank 3 may be shaped in any suitable way. Preferably, the water tank 3 is detachably arranged, so that the user is capable of bringing the water tank 3 to a tap or the like in order to fill the water tank 3, without having to move the entire coffee maker 1. The present invention is also applicable in the context of coffee makers which do not comprise a water tank, but which are connected to some kind of water supplying system through a suitable closing device, such as a tap.

A third shown component of the coffee maker 1 is a pump 4 for forcing the water to flow through the coffee maker 1, wherein the pump 4 may be of any suitable type.

A fourth shown component of the coffee maker 1 is a boiler 6 for heating the water, which boiler 6 comprises a container 61 for containing water and heating means 62 for heating the water to a predetermined temperature. In FIG. 1, the container 61 is diagrammatically depicted as a dashed rectangle, and the heating means 62 are depicted as a continuous rectangle.

The boiler 6 may be of any suitable type. The boiler 6 and the pump 4 are interconnected by means of a pump tube 5. When the pump 4 is operated, the water is forced to flow from the pump 4 to the boiler 6, through the pump tube 5.

A fifth shown component of the coffee maker 1 is a brew chamber 8. The brew chamber 8 and the boiler 6 are interconnected by means of a boiler tube 7. The brew chamber 8 is adapted to accommodating at least one coffee pad. During operation, the actual process of making coffee takes place inside the brew chamber 8, as in the brew chamber 8, the water is forced to flow through the coffee pad.

A sixth shown component of the coffee maker 1 is an outlet nozzle 9, which is directly connected to the brew chamber 8, and which serves for letting out freshly brewed coffee from the coffee maker 1.

A seventh shown component of the coffee maker 1 is a controller 10, which is arranged such as to receive signals corresponding to the state of various components of the coffee maker 1, for example the position of the buttons 21, 22, 23, which is adapted to processing these signals according to a predetermined schedule, and which is adapted to controlling the operation of operable components, for example the indicator light 24 and the pump 4.

When a user decides to apply the coffee maker 1 to make one or two cups of coffee, he first needs to prepare the coffee maker 1 by following the steps listed below:

1) filling the water tank 3 with water. In the process, the user needs to take care that the quantity of water in the water tank 3 is at least the quantity of water needed for making the cup(s) of coffee;

2) placing at one coffee pad in the brew chamber 8 in case he desires to obtain one cup of coffee, and placing two coffee pads in the brew chamber 8 in case he desires to obtain two cups of coffee. The coffee maker 1 may for example comprise a separate carrier for receiving the coffee pad(s), which may easily be inserted in the brew chamber 8;

3) placing one or two coffee cups in the proper position for receiving coffee from the coffee maker 1.

When the coffee maker 1 is applied, two successive procedures are carried out, which will hereinafter be referred to as primary procedure and secondary procedure. In general, the primary procedure is aimed at heating water by means of the boiler 6, while the secondary procedure is aimed at actually making coffee by forcing water to flow through the coffee pad(s) accommodated inside the brew chamber 8. During the secondary procedure, the pump 4 is activated, and as fresh water enters the boiler 6 on one side, the heated water is forced to flow out of the boiler 6 on another side. In this way, the boiler 6 never gets empty. As an advantageous consequence, it is not necessary to fill the boiler 6 at the start of the primary procedure, so it is not necessary to activate the pump 4 during the primary procedure.

The coffee maker 1 is activated by pressing the main button 21. As soon as the controller 10 receives a signal that is generated on the basis of pressing the main button 21, the controller 10 starts the primary procedure, which is aimed at heating the water inside the boiler 6 to a predetermined temperature, for example 95° C.

At the start of the primary procedure, the controller 10 activates the heating means 62. The heating means 62 are operated until the predetermined temperature has been reached. A temperature sensor or other suitable means may be applied for providing the controller 10 with a signal representing the temperature of the water inside the boiler 6, so that the controller 10 is capable of determining a right moment for deactivating the heating means 62.

During the operation of the heating means 62, the controller 10 activates the indicator light 24 such as to inform the user that the coffee maker 1 is busy. For example, the busy state of the coffee maker 1 may be indicated by letting the indicator light 24 blink relatively slowly, wherein the indicator light 24 is alternately 1 second activated and 1 second deactivated. It will be understood that this is just one of the numerous possible ways of indicating the busy state of the coffee maker 1. It is not even necessary to use a single indicator light 24 as an indicator. Other suitable types of indicators may be applied instead.

As soon as the temperature of the water inside the boiler 6 has reached the predetermined level and the heating means 62 are deactivated, the controller 10 activates the indicator light 24 such as to inform the user that the coffee maker 1 is ready for further use. For example, the ready state of the coffee maker 1 may be indicated by letting the indicator light 24 burn continuously. The step of activating the indicator light 24 to indicate the ready state of the coffee maker 1 is a last step of the primary procedure.

After the primary procedure has been ended, the secondary procedure is started when the user presses one of the one cup button 22 and the two cups button 23.

In case the user presses the one cup button 22, the pump 4 is activated during a predetermined length of time, such as to force a quantity of heated water associated with one cup of coffee to flow from the boiler 6 to the brew chamber 8, to flow through the coffee pad in the brew chamber 8, and to exit the coffee maker 1 via the outlet nozzle 9. At the same time, fresh water is forced to flow from the water tank 3 to the boiler 6. In fact, the fresh water forces the heated water to exit the boiler 6, wherein mixing of the fresh water with the heated water is avoided. In the process, the indicator light 24 is activated to indicate the busy state of the coffee maker 1.

In case the user presses the two cups button 23, the pump 4 is activated during a predetermined length of time, which is approximately twice the predetermined length of time during which the pump 4 is activated in case the user presses the one cup button 22. In the process, the indicator light 24 is activated to indicate the busy state of the coffee maker 1.

According to an important aspect of the present invention, the volume of the container 61 of the boiler 6 is smaller than the volume of the quantity of water associated with two cups. Therefore, during operation of the pump 4, the entire quantity of heated water is forced to flow from the boiler 6 to the brew chamber 8 first, after which a quantity of fresh water is forced to flow to the brew chamber 8 as well, through the boiler 6. In the following, the quantity of heated water which is provided first is also referred to as first quantity of water, and the quantity of fresh water which is forced to flow from the water tank 3 to the brew chamber 8 via the boiler 6 during one and the same coffee making process is also referred to as second quantity of water.

During the time the second quantity of water flows through the boiler 6, the heating means 62 may be activated, but this is not necessary. In case the heating means 62 are not activated, the second quantity water is heated anyway, assuming that the heating means 62 and other parts of the boiler 6 are still hot. Naturally, the obtained temperature will not be as high as the temperature of the heated water. It is noted that the obtained temperature is not only dependent of the temperature of the heating means 62 and the other parts of the boiler 6, but also of the pumping speed. The faster the water flows through the boiler 6, the lower the obtained temperature is.

According to the present invention, the two cups of coffee are obtained by first forcing the first quantity of water to flow through the coffee pads accommodated inside the brew chamber 8, and subsequently forcing the second quantity of water to flow through the coffee pads accommodated inside the brew chamber 8 as well, wherein the first quantity is directly followed by the second quantity. For example, the first quantity may be 75% of the total quantity needed for making two cups of coffee. Naturally, in such a case, the second quantity is 25% of this total quantity.

In case the second quantity follows the first quantity through the same boiler 6, in accordance with the procedure as described in the above, it is important that the volume of the container 61 of the boiler 6 substantially corresponds to the volume of the first quantity.

Preferably, according to the present invention, the temperature of the first quantity of water is higher than 90° C., for example about 95° C., and the temperature of the second quantity of water is lower than 90° C. A situation in which the temperature of the second quantity of water is lower than 85° C., while the temperature of the first quantity of water is higher than 90° C., is even more preferred. However, it will be understood that the temperature of the second quantity of water should not be so low that the temperature of the obtained coffee in the cup(s) is experienced by the user as being too low.

By applying different methods for making one cup of coffee and for making two cups of coffee, wherein the method for making two cups of coffee comprises supplying the water in at least two portions having different temperatures, it is achieved that the taste of the coffee is substantially the same for both quantities. Contrariwise, according to the state of the art, there is no principal difference between these methods, as both methods comprise heating a quantity of water to a predetermined temperature and forcing this quantity of heated water to flow through the coffee pad(s) accommodated inside the brew chamber 8, wherein the quantity associated with two cups of coffee is twice as large as the quantity associated with one cup of coffee. Consequently, in the known situation, the time it takes for the water to flow through the coffee pads in case two cups of coffee are made is approximately twice as long as the time it takes for the water to flow through the coffee pad in case one cup of coffee is made. The time it takes for the water to flow through the coffee pad(s) is also known as extraction time. As the taste of the obtained coffee is influenced by the length of the extraction time, the taste of the coffee obtained as one cup differs from the taste of the coffee obtained as two cups. When the measures according to the present invention are taken, this difference is removed, and it is achieved that the taste of the coffee is independent of the obtained quantity. It is noted that the extraction time is not influenced by the measures according to the present invention, so that the extraction time associated with making two cups of coffee remains approximately twice as long as the extraction time associated with making one cup of coffee.

It will be clear to a person skilled in the art that the scope of the present invention is not limited to the examples discussed in the foregoing, but that several amendments and modifications thereof are possible without deviating from the scope of the present invention as defined in the attached claims.

For example, the coffee maker 1 may be provided with two boilers 6, wherein, during operation of the coffee maker 1, the first quantity of water is heated in one of the boilers 6, the second quantity of water is heated in another of the boilers 6, and wherein the obtained temperature of the first quantity of water differs from the temperature of the second quantity of water. Preferably, in such an embodiment, the heating means of the boiler for heating the second quantity of water are only activated in case the two cups button 23 has been pressed by the user. This embodiment is more complex than the described embodiment having only one boiler 6, wherein the second quantity of water is heated as it flows through the hot boiler 6. For example, the embodiment having two boilers 6 needs to comprise controllable valves or the like, so that, during operation of the pump 4, the first quantity and the second quantity may be separately conducted through the brew chamber 8.

Within the scope of the present invention, during a coffee making process, it is possible that the quantity of water needed to make a desired quantity of coffee is supplied in two portions having different temperatures, as has been described in the above, but it is also possible that the quantity of water needed to make a desired quantity of coffee is supplied in three or more portions having different temperatures.

Besides at least one boiler 6, the coffee maker 1 may comprise a cold water reservoir. When such an embodiment of the coffee maker 1 is applied for making a quantity of coffee by successively supplying at least two different portions of water having different temperatures, at least one of the portions of water may be derived from the cold water reservoir. In general, it is not necessary that all supplied portions of water are heated; at least one portion may be unheated or even cooled.

In the foregoing, the present invention has been described in the context of a coffee making process. However, the present invention is not only applicable in this context, but in the context of any kind of beverage making process in which a quantity of water is conducted through a quantity of extractable material.

In case the present invention is applied in the context of making two different quantities of beverage, the larger quantity does not necessarily need to be twice the smaller quantity. Within the scope of the present invention, the ratio between the different quantities is not essential and may have any value.

Naturally, in practice, when two portions of water having different temperatures follow each other, it is impossible to point out a borderline separating these two portions. Instead, there is always a transition area in which the temperature gradually changes from one temperature to another temperature. However, the fact that there is no distinct borderline between successive portions of water does not alter the fact that the portions are discernable at an overall level. Therefore, the present invention also covers beverage making procedures in which at least two portions of water having different temperatures are successively supplied, and in which a transition area between these two portions exists.

For the purpose of heating the water, the coffee maker 1 does not necessarily need to comprise a boiler 6 having a container 61 for containing the water. The water may also be heated by means of a so-called flow-through heater, which comprises a tube-like conducting space for conducting the water and heating means for heating the water. When the flow-through heater is applied, during operation of the pump 4, the water is forced to flow through the heater. In the process, the water is heated by the heating means. A main difference between a boiler 6 and a flow-through heater is that a boiler 6 is principally arranged for heating a quantity of water which remains in its container 61 for a while, whereas a flow-through heater is principally arranged for heating water that is flowing through its conducting space.

In a coffee maker 1 comprising a flow-through heater, the heating means of the heater are controlled by a controller. By means of the controller, the supply of power to the heating means may be varied, so that the temperature of the water flowing through the heater may be varied. In this way, it is possible to supply successive portions of water having different temperatures. For example, the controller may be programmed such as to stepwise decrease the power that is supplied to the heating means, so that successive portions of water having increasingly lower temperatures are supplied. However, a great many other ways of controlling the supply of power to the heating means over time are also conceivable.

In the foregoing, a coffeemaker 1 comprising a boiler 6 for heating water to a predetermined temperature, and a pump 4 for forcing a predetermined quantity of water to flow through a filter containing ground coffee beans is described.

The coffeemaker 1 is capable of making a single quantity of coffee and a double quantity of coffee. The volume of a container 61 of the boiler 6 is at least equal to the volume of the total quantity of water required for obtaining the single quantity of coffee, and smaller than the volume of the total quantity of water required for obtaining the double quantity of coffee. During the process of making the double quantity of coffee, a first quantity of water, which is a part of the required total quantity of water, is heated inside the boiler 6 to the predetermined temperature. Subsequently, this first quantity is conducted through the coffee filter, whereupon a second quantity of fresh water is conducted through the coffee filter as well. As the second quantity of water flows through the hot boiler 6, this quantity gets heated as well. The extent to which the second quantity is heated depends on the operation of the heating means 62, and the temperature of the various parts of the boiler 6, which may still be relatively high as a result of the heating-up process of the first quantity.

By supplying the water required for making coffee in two portions having different temperatures, the taste of the obtained coffee is influenced. When a double quantity of coffee is made according to the above-described procedure, the obtained coffee has a similar taste as coffee, which is made in a single quantity, for the purpose of which use is made exclusively of water that has been heated inside the boiler 6 to the predetermined temperature.

1. Method for making a predetermined quantity of beverage such as coffee or tea, wherein a predetermined quantity of water is conducted through a quantity of extractable material, and wherein the predetermined quantity of water is supplied in at least two portions having different temperatures.

2. Method according to claim 1, wherein the temperature of a preceding portion of the predetermined quantity of water is higher than the temperature of a following portion of the predetermined quantity of water.

3. Method according to claim 1, wherein the predetermined quantity of water is supplied in two portions, wherein the temperature of a first portion is higher than 90° C., and wherein the temperature of a second portion is lower than 90° C.

4. Method according to claim 1, wherein a preceding portion of the predetermined quantity of water is heated in a boiler having a container for containing water and heating means for heating the water, wherein said portion stays inside the boiler until a predetermined temperature is reached, and wherein a flow of at least one following portion of the predetermined quantity of water is conducted through the boiler, following a flow of the preceding portion of the predetermined quantity of water exiting the boiler.

5. Method according to claim 4, wherein the heating means of the boiler are activated while the following portion of the predetermined quantity of water flows through the boiler.

6. Method for making one of a predetermined first quantity and a predetermined second quantity of beverage such as coffee or tea, wherein the second quantity is larger than the first quantity, wherein, for the purpose of making the first quantity of beverage, a predetermined first quantity of water is conducted through a quantity of extractable material, wherein the first quantity of water is supplied in one portion, and wherein, for the purpose of making the second quantity of beverage, a predetermined second quantity of water is conducted through a quantity of extractable material, wherein the second quantity of water is supplied in at least two portions having different temperatures.

7. Method according to claim 6, wherein the temperature of a preceding portion of the predetermined second quantity of water is higher than the temperature of a following portion of the predetermined second quantity of water.

8. Method according to claim 6, wherein the predetermined second quantity of water is supplied in two portions, wherein the temperature of a first portion is higher than 90° C., and wherein the temperature of a second portion is lower than 90° C.

9. Method according to claim 6, wherein a preceding portion of the predetermined second quantity of water is heated in a boiler having a container for containing water and heating means for heating the water, wherein said portion stays inside the boiler until a predetermined temperature is reached, and wherein a flow of at least one following portion of the predetermined second quantity of water is conducted through the boiler, following a flow of the preceding portion of the predetermined second quantity of water exiting the boiler.

10. Method according to claim 9, wherein the heating means of the boiler are activated while the following portion of the predetermined second quantity of water flows through the boiler.

11. Device for making a predetermined quantity of beverage by applying the method according to claim 1, comprising a boiler having a container for containing water and heating means for heating the water, wherein the volume of the container is smaller than the volume of the predetermined quantity of water.

12. Device according to claim 11, wherein the volume of the container of the boiler substantially corresponds to the volume of one of the portions of the predetermined quantity of water, in which the water is supplied during a beverage making process.

13. Device for making one of a predetermined first quantity of beverage and a predetermined second quantity of beverage by applying the method according to claim 6, wherein the second quantity is larger than the first quantity, comprising a boiler having a container for containing water and heating means for heating the water, wherein the volume of the container is at least equal to the volume of the predetermined first quantity of water, and smaller than the volume of the predetermined second quantity of water.

14. Device according to claim 13, wherein the volume of the container of the boiler substantially corresponds to the volume of one of the portions of the predetermined second quantity of water, in which the water is supplied during a beverage making process.

15. Device for making a predetermined quantity of beverage by applying the method according to claim 1, comprising a flow-through heater having a conducting space for conducting water and heating means for heating the water, and a controller for controlling a supply of power to the heating means of the flow-through-heater, wherein the controller is programmed such as to vary the supply of power to the heating means over time.

16. Device for making one of a predetermined first quantity of beverage and a predetermined second quantity of beverage by applying the method according to claim 6, wherein the second quantity is larger than the first quantity, comprising a flow-through heater having a conducting space for conducting water and heating means for heating the water, and a controller for controlling a supply of power to the heating means of the flow-through-heater, wherein the controller is programmed such as to keep the supply of power to the heating means at a constant level in case the first quantity of beverage needs to be made, and wherein the controller is programmed such as to vary the supply of power to the heating means over time in case the second quantity of beverage needs to be made.
